(19) United States
(12) Patent Application Publication
(10) Pub. No.: US 2026/0292383 A1
(43) Pub. Date: Sep. 24, 2026

(54) Smart Touchscreen Headphones

(71) Applicant: Natan Or Ben Zvi, Ofakim (IL)

(72) Inventor: Natan Or Ben Zvi, Ofakim (IL)

(21) Appl. No.: 19/324,087

(22) Filed: Sep. 9, 2025

Related U.S. Application Data
(60) Provisional application No. 63/776,042, filed on Mar. 22, 2025.

(51) Int. Cl. H04R 1/10; G06F 1/16; G06F 3/01; H04R 1/02

(52) U.S. Cl. CPC H04R 1/1008; G06F 1/163; G06F 1/1643; G06F 3/016; H04R 1/028; H04R 2400/03; H04R 2420/07

(57) ABSTRACT

Embodiments of the present invention may comprise a device which may be referred to as a pair of headphones. The device may have a right-hand side earpiece housing and a left-hand side earpiece housing, each with a driver configured to output acoustic signals to be heard by a user. Each the right-hand side earpiece housing and the left-hand side earpiece housing may have a touchscreen display configured to display a visual output and receive tactile commands from the user. The device may have a removable network communication arrangement communicatively coupled to a mobile communication network. The device may also have a processing arrangement and a data storage arrangement capable of downloading, storing, and processing audio files without the need for an intermediary device such as a smartphone.

### CROSS-REFERENCE TO RELATED APPLICATIONS

This application claims priority from U.S. Provisional Patent Application Number 63/776,042, filed on Mar. 22, 2025, which is hereby incorporated by reference.

### BACKGROUND OF THE INVENTION

Headphones and earphones have become integral to modern life, serving as personal audio devices that allow users to immerse themselves in music, podcasts, and other audio content. Music, through headphones, can have profound effects on human life, influencing mood, productivity, and mental well-being. It provides an outlet for emotional expression, offers a form of escapism, and can even enhance cognitive performance by blocking out distractions. Studies have shown that music can improve concentration, reduce stress, and promote relaxation. Headphones enable this intimate experience, providing users with a direct, personalized connection to their sound environment.

The headphone and earphone industry has seen significant advancements in recent years. One of the most notable improvements is the development of noise-cancelling technology, which helps block out ambient noise for a more immersive audio experience. Wireless models, powered by Bluetooth, have also gained popularity, offering greater convenience and freedom of movement. High-resolution audio, adaptive sound features, and enhanced battery life have elevated the user experience. Additionally, ergonomic designs and smart features, like touch controls and voice assistants, have made headphones more comfortable and user-friendly.

However, several challenges remain within the headphone and earphone industry. One issue is the comfort and fit, especially for in-ear models, which can cause discomfort or ear fatigue during prolonged use. Another problem is the potential for hearing damage. Listening at high volumes for extended periods, particularly through earphones, can lead to permanent hearing loss. Additionally, connectivity issues with Bluetooth headphones, such as lag or connection dropouts, can be frustrating for users. The durability of materials and battery life, especially for wireless models, also remains a concern.

Furthermore, the non-immersive sound output limits the joy of listening to music for a user. Offline music playback is also a major problem with the present headphones and earphones.

Furthermore, the lack of complete music playback controls and the visual output in the present headphones and earphones also limits their usage and functionality.

Furthermore, and most importantly, the inability of the present headphones to stream multimedia streaming platforms independently without the need for a mobile phone is a major problem.

These inefficiencies and limitations in the presently available headphones have created a need for improved solutions that can enhance the utility of the headphones and music listening experience for the user.

Therefore, in the light of the foregoing discussion, there exists a need to overcome the aforementioned drawbacks.

### SUMMARY OF THE INVENTION

Embodiments of the present invention may comprise a device. The device may be a pair of headphones intended to be worn over a user's ears so that the user can listed to audio content. The device may have a processing arrangement. The device may also have a data storage arrangement. The data storage arrangement may comprise a non-transitory computer-readable medium containing instructions that, when executed by the processing arrangement, cause the processing arrangement to perform a series of steps. The data storage arrangement may be removably configured within the device.

A network communication arrangement may be removably configured within the device, and may be communicatively coupled to a mobile communication network. Examples of the mobile communication network include but are not limited to a cellular network, satellite network, or wireless local area network. The network communication arrangement may comprise a SIM memory configured to store subscriber identify information, authentication data, and network access parameters. The network communication arrangement may further comprise a SIM processor coupled to the SIM memory such that computer-readable data/instructions may be transferred between the SIM processor and the SIM memory. The SIM processor may be configured to execute instructions for performing authentication with the mobile communication network. These instructions may be stored in the SIM memory as computer-readable instructions, and may be provided to the SIM processor by the SIM memory. The network communication arrangement may further comprise a SIM contact interface that may be configured to provide electrical communication between the SIM processor and the processing arrangement of the device.

The SIM processor may be configured to transmit the subscriber identity information, authentication data, and network access parameters from the SIM memory to the processing arrangement of the device. This transmission of information may be in response to a request signal received through the SIM contact interface. In this manner, the network communication arrangement may allow the device itself to connect to the mobile communication network without the need for an intermediary device such as a smartphone or the like. Furthermore, the processing arrangement and data storage arrangement of the device may allow the device to download audio content from the mobile communication network, store the audio content, and process the audio content without the need for an intermediary device such as a smartphone or the like.

The device may have a right-hand side earpiece housing and a left-hand side earpiece housing connected by a support member. The right-hand side earpiece housing may be configured to be arranged relative to a right ear of a user, and the left-hand side earpiece housing may be configured to be arranged relative to a left ear of a user. The right-hand side earpiece may have a right-hand side outward surface, a right-hand side inward surface, and a first driver configured to output acoustic signals. The left-hand side earpiece may have a left-hand outward surface, a left-hand side inward surface, and a second driver configured to output acoustic signals. When the device is donned by a user, the right-hand side inward surface may contact the user's right ear and/or be configured to cover the user's right ear, and the left-hand side inward surface may contact the user's left ear and/or be configured to cover the user's left ear.

The first driver and the second driver may each have a coil and one or more magnets. Electricity provided to the first driver and the second driver may induce a magnetic field in the first driver and second driver, which may cause the coil in each the first driver and the second driver to move. The movement of the coils may cause a diaphragm of each the first driver and the second driver to vibrate, causing sound waves that may be heard by the user.

The data storage arrangement may be configured to store audio files in the form of computer-readable data. The audio files may be obtained from the mobile communication network via the network communication arrangement. The audio files may originate from another device and may be transmitted to the device via the mobile communication network. The processing arrangement may cause the first driver and the second driver to convert the audio files to acoustic signals and output the acoustic signals to the user. The acoustic signals outputted to the user by the first driver and the second driver may allow the user to listen to music, listen to the audio of a television program, or hear the audio of a telephone call.

A first touchscreen display may be arranged on the right-hand side outward surface, and a second touchscreen display may be arranged on the left-hand side outward surface. The first touchscreen display may be configured to display a dynamically updated first visual output. The first touchscreen display may further be configured to receive a first tactile command from the user such that the first visual output is dynamically updated in response to the first tactile command. The second touchscreen display may be configured to display a dynamically updated second visual output. The second touchscreen display may further be configured to receive a second tactile command from the user such that the second visual output is dynamically updated in response to the second tactile command.

In some embodiments, the first visual output and the second visual output are the same. In such embodiments, the first visual output and the second visual output may be dynamically updated simultaneously, and may be dynamically updated in response to the first tactile command or in response to the second tactile command. In other embodiments, the first visual output and the second visual output may be different visual outputs. In such embodiments, the first visual output and the second visual output may be dynamically updated asynchronously. In such embodiments, the first visual output may be dynamically updated only in response to the first tactile command, and the second visual output may be dynamically updated only in response to the second tactile command.

The first tactile command and the second tactile command may be performed simultaneously to perform a third tactile command. In some embodiments, the first tactile command and second tactile command may be performed within 1 second of one another in order to perform the third tactile command. In some embodiments, both the first visual output and the second visual output may be dynamically updated in response to the third tactile command. In other embodiments, only one of the first tactile command or the second tactile command may be dynamically updated in response to the third tactile command.

In some embodiments, the first tactile command may cause the first driver and/or the second driver to produce a first auditory output. The second tactile command may cause the first driver and/or the second driver to produce a second auditory output. The third tactile command may cause the first driver and the second driver to produce a third auditory output. The first auditory output, second auditory output, and third auditory output may be a change in sound waves produced by the first driver and/or second driver. For example, the first auditory output may be activating the first driver and second driver to generate sound waves so the user can listen to music using the device. The second auditory output may be increasing the intensity of the sound emitted by the first driver and the second driver to increase the volume of the music heard by the user. The third auditory output may be a temporary deactivation of the first driver and/or second driver to stop the music.

The first tactile command, second tactile command, and/or third tactile command may cause the processing arrangement to cause various components of the device other than the first driver, second driver, first touchscreen display, and second touchscreen display to perform a function. For example, the first tactile command, second tactile command, and/or third tactile command may cause the processing arrangement to receive the subscriber identity information, authentication data, and network access parameters from the SIM processor of the network communication arrangement. This allows a user to decide when to communicatively couple the device to the mobile communication network, giving the user more control over the connectivity of the device. The removable nature of the network communication device allows alternative network communication devices to be removably configured within the device such that the device can be communicatively coupled to different mobile communication networks per the user's choice.

The device may have an electric motor. The electric motor may be configured to produce vibrations in the right-hand side earpiece housing and the left-hand side earpiece housing. The processing arrangement may cause the electric motor to produce vibrations in a manner such that the vibrations start, stop, and increase in magnitude simultaneously with the acoustic signals outputted to the user by the first driver and the second driver. In some embodiments, the first tactile command, second tactile command, and/or third tactile command may cause the processing arrangement to cause the electric motor to be activated and to produce the vibrations in this manner.

The device may have a rechargeable battery that may power the various electrical components of the device, including but not limited to the first driver, the second driver, the first touchscreen display, the second touchscreen display, the processing arrangement, the data storage arrangement, the network communication arrangement, and the electric motor. The device may have a charging port into which a charger comprising at least one wire may be inserted to form an electrical connection with the rechargeable battery to recharge the rechargeable battery. This allows the rechargeable battery to be recharged without removing the rechargeable battery from the device.

Embodiments of the present invention may further comprise a system. The system may utilize a mobile communication network, which may be the same mobile communication network described previously herein. The system may also utilize a central database. The central database may be communicatively coupled to the mobile communication network. The central database may comprise a central database memory comprising a non-transient computer-readable medium that may store files in the form of computer-readable instructions/data. Some of these files may be audio files that, when processed by a processing arrangement of an electronic music playing device, cause one or more drivers of the electronic music playing device to generate sound waves such that a user hears music.

The system may also utilize a device. The device may be the same device described previously herein, or may be a similar device intended to be worn over a user's ears to allow a user to listen to audio such as but not limited to music, television programs, or telephone calls. The device may be the electronic music playing device described previously herein. The audio files stored in the central database of the system may be transmitted from the central database memory to a data storage arrangement of the device via the mobile communication network upon receipt of a tactile command from a user of the device. Upon receipt of the audio files by the data storage arrangement of the device, a processing arrangement of the device may cause drivers of the device to output acoustic signals to the user based on the content of the audio files.

Whether the device of the system is the same device described previously herein or a similar device, the device of the system may comprise a network communication arrangement which may be removably configured within the device. The network communication arrangement may be communicatively coupled to the mobile communication network. The network communication arrangement may comprise a SIM memory configured to store subscriber identify information, authentication data, and network access parameters. The network communication arrangement may further comprise a SIM processor coupled to the SIM memory such that computer-readable data/instructions may be transferred between the SIM processor and the SIM memory. The SIM processor may be configured to execute instructions for performing authentication with the mobile communication network. These instructions may be stored in the SIM memory as computer-readable instructions, and may be provided to the SIM processor by the SIM memory. The network communication arrangement may further comprise a SIM contact interface that may be configured to provide electrical communication between the SIM processor and the processing arrangement of the device. The electrical communication between the SIM processor and the processing arrangement of the device may allow the SIM process to transmit subscriber identity information, authentication data, and network access parameters to the processing arrangement of the device in response to a request signal received through the SIM contact interface.

### BRIEF DESCRIPTION OF DRAWINGS

FIG. 1 shows a front view of a device according to embodiment of the present invention.

FIG. 2 shows a right-side view of the device of FIG. 1.

FIG. 3 shows a diagram of electrical connections between various components of a device according to embodiments of the present invention.

FIG. 4 shows a diagram of a system according to embodiments of the present invention.

### DETAILED DESCRIPTION OF THE INVENTION

The description provided herein describes example embodiments of the present invention and is not intended to limit the present invention to any particular embodiment, features, components, mechanisms, materials, use, functionality, or any other property. Furthermore, the drawings provided herein show example embodiments of the present invention and are not intended to limit the present invention to any particular embodiment, features, components, mechanisms, materials, use, functionality, or any other property.

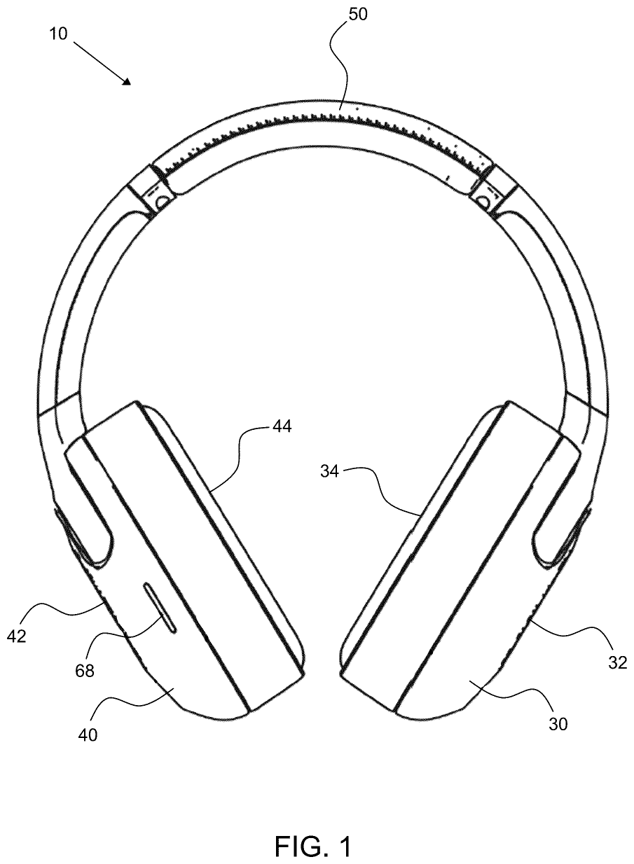

As shown in FIG. 1, a device 10 has a right-hand side earpiece housing 30 and a left-hand side earpiece housing 40 connected by a support member 50. The support member 50 may have a ratchet mechanism that increases or decreases an arc length of the support member 50 to increase or decrease the distance between the right-hand side earpiece housing 30 and the left-hand side earpiece housing 40. The support member 50 may have padding that contacts the top of a user's head when the device 10 is configured such that the right-hand side earpiece housing 30 is configured over the user's right ear and the left-hand side earpiece housing 40 is configured over the user's left ear.

The right-hand side earpiece housing 30 has a right-hand side inward surface 34 that faces towards the left-hand side earpiece housing 40, and a right-hand side outward surface 32 that faces away from the left-hand side earpiece housing 40. Likewise, the left-hand side earpiece housing 40 has a left-hand side inward surface 44 that faces towards the right-hand side earpiece housing 30, and a left-hand side outward surface 42 that faces away from the right-hand side earpiece housing 30. Padding may be attached to both the right-hand side inward surface 34 and the left-hand side inward surface 44 such that the padding contacts a user when the device 10 is configured such that the right-hand side earpiece housing 30 is configured over the user's right ear and the left-hand side earpiece housing 40 is configured over the user's left ear.

A SIM module 68 is configured within the left-hand side earpiece housing 40. The SIM module 68 may be a recessed portion such as a slot that accepts a network communication arrangement (not shown in FIG. 1.) Electrical connections may be exposed inside of the SIM module 68 such that when the network communication arrangement is removably configured within the SIM module 68, a SIM contact interface of the network communication arrangement contacts the exposed electrical connections to transfer information between the network communication arrangement and other electronic components of the device 10.

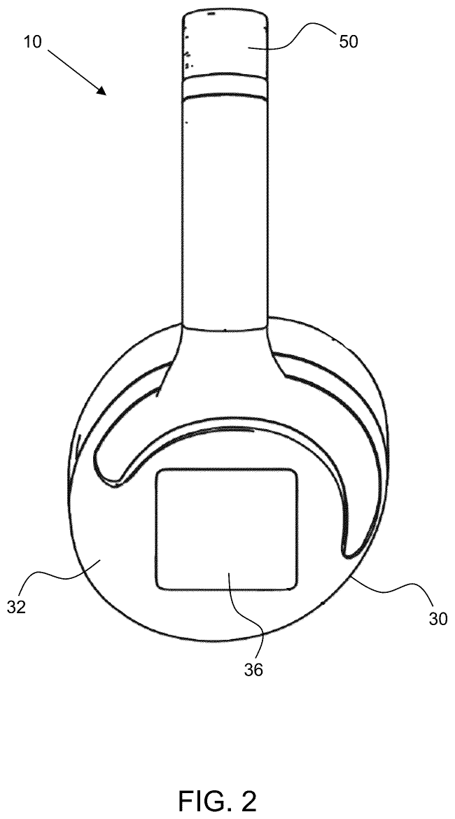

As shown in FIG. 2, a first touchscreen display 36 is configured on the right-hand side outward surface 32 of the right-hand side earpiece housing 30. The first touchscreen display 36 may cover a portion of the right-hand side outward surface 32. Alternatively, the first touchscreen display 36 may cover the entirety of the right-hand side outward surface 32. The device 10 may also have a second touchscreen display (not shown in FIG. 2) configured on the left-hand side outward surface 42 of the left-hand side earpiece housing 40. The second touchscreen display may be aesthetically and functionally similar, or even aesthetically and functionally identical, to the first touchscreen display 36.

The first touchscreen display 36 and the second touchscreen display may comprise a plurality of lights that are dynamically activated, deactivated, and altered in brightness to produce a video image on the first touchscreen display 36 and the second touchscreen display. Conductive material may be layered onto the first touchscreen display 36 and the second touchscreen display. This conductive material may form an electrostatic field. When a user touches the first touchscreen display 36 or the second touchscreen display, the electrostatic field may be interrupted. The specific location of the first touchscreen display 36 or second touchscreen display in which the electrostatic field is interrupted may be determined and may be interpreted as a tactile input from the user.

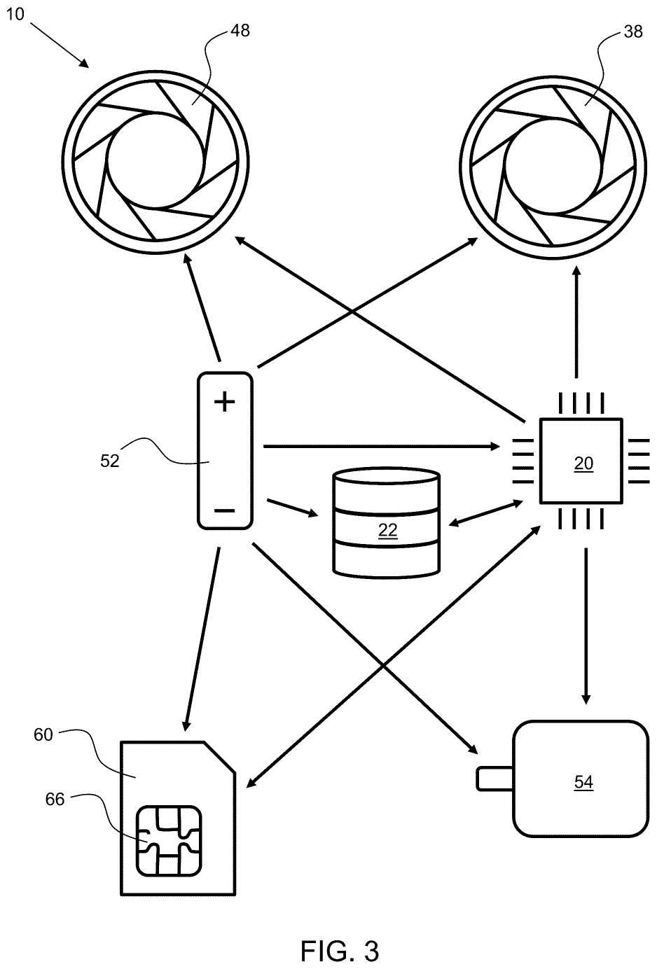

As shown in FIG. 3, a rechargeable battery 52 powers various electronic components of the device 10, including but not limited to the network communication arrangement 60, a processing arrangement 20, a data storage arrangement 22, a first driver 38, a second driver 48, and an electric motor 54. Not shown in FIG. 3 are the first touchscreen display 36 and the second touchscreen display, which may also be powered by the rechargeable battery 52.

The data storage arrangement 22 may contain a non-transitory, computer-readable medium containing instructions that, when executed by the processing arrangement 20, cause the processing arrangement 20 to perform a series of steps. The instructions stored in the data storage arrangement 22 may be computer-readable instructions in the form of electrical signals. The processing arrangement 20 may, using the instructions stored within the data storage arrangement 22, transmit electrical signals to the first driver 38, the second driver 48, the electric motor 54, the network communication arrangement 60, the data storage arrangement 22, the first touchscreen display 36, and the second touchscreen display. The electrical signals sent by the processing arrangement 20 to the data storage arrangement 22 may cause the data storage arrangement 22 to store additional information in the form of non-transitory computer-readable data/instructions.

The electrical signals sent by the processing arrangement 20 to the electric motor 54 may activate the electric motor 54, deactivate the electric motor 54, or change the speed at which the electric motor 54 operates. The electric motor 54 may use magnetic induction to translate electrical energy provided by the rechargeable battery 52 into mechanical energy. The mechanical energy provided by the electric motor 54 may be used to produce vibrations within the device 10. The electrical signals sent by the processing arrangement 20 to the electric motor 54 may determine the intensity and frequency of these vibrations.

The electrical signals sent by the processing arrangement 20 to the first driver 38 and the second driver 48 may cause the first driver 38 and the second driver 48 to output acoustic signals that may be heard by a user of the device 10. The first driver 38 may be configured within the right-hand side earpiece housing 30 and the second driver 48 may be configured in the left-hand side earpiece housing 40.

The electrical signals send by the processing arrangement 20 to the first touchscreen display 36 and the second touchscreen display may alter the visual outputs displayed on the first touchscreen display 36 and the second touchscreen display.

The electrical signals sent by the processing arrangement 20 to the network communication arrangement 60 may cause the network communication arrangement 60 to send and receive computer-readable data/instructions over a mobile communication network. The network communication arrangement 60 may transmit the computer-readable data/instructions received from the mobile communication network to the processing arrangement 20 and/or the data storage arrangement 22. In some embodiments, the computer-readable data/instructions received from the mobile communication network by the network communication arrangement 60 may be transmitted from the network communication arrangement 60 to the data storage arrangement 22 by the processing arrangement 20. Electrical communication between the processing arrangement 20 and the network communication arrangement 60 may be facilitated by a SIM contact interface 66 of the network communication arrangement 60.

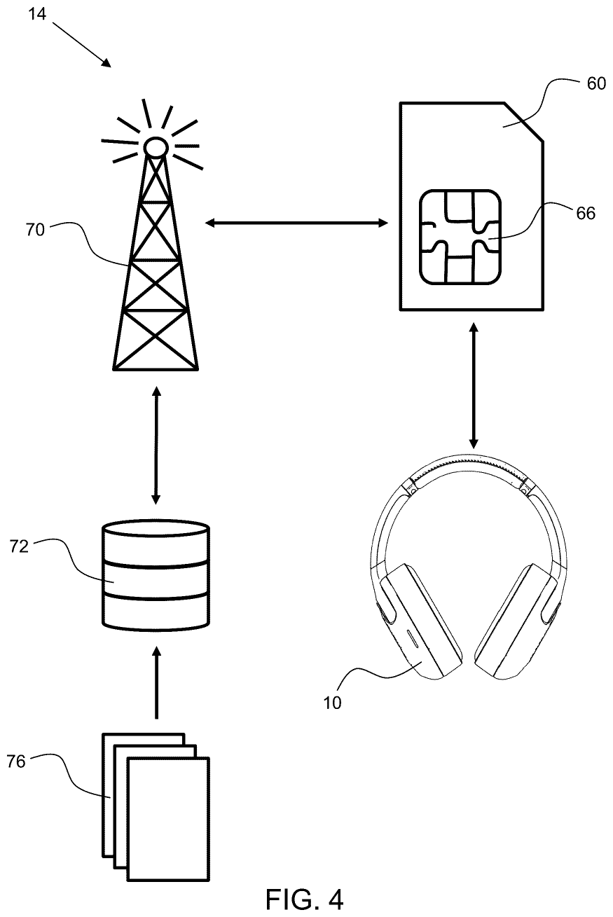

As shown in FIG. 4, a system 14 includes a mobile communication network 70 in communication with a device 10 via a network communication arrangement 60 of the device 10. A central database 72 may store computer-readable data/instructions that may be transmitted to the device 10 via the mobile communication network 70. Some of these computer-readable data/instructions may be audio files 76. The audio files exist as computer-readable data/instructions that, when read by the processing arrangement 20 of the device 10, cause the processing arrangement 20 of the device 10 to activate, deactivate, or otherwise manipulate the first driver 38, second driver 48, first touchscreen display 36, second touchscreen display, and/or electric motor 54 to provide audio, visual, and/or tactile output to the user of the device 10.

Since the device 10 comprises its own processing arrangement 20, data storage arrangement 22, and removable network communication arrangement 60, audio files 76 may be transmitted to the device 10 directly via the mobile communication network 70 and stored within the device 10 itself rather than being transmitted to and stored within another electric device such as a smartphone. This is in contrast to other headphones in the art that must be in electronic communication with another device such as a smartphone in order to access audio files. The removable nature of the network communication arrangement 60 allows different network communication arrangements 60 associated with different mobile communication networks 70 to be configured in the device 10. This allows the user of the device 10 to choose which mobile communication network 70 to connect the device 10, as well as to change the mobile communication network 70 to which the device is connected.

What is claimed is:

1. A device comprising:
a processing arrangement;
a data storage arrangement comprising a non-transitory computer-readable medium containing instructions that, when executed by the processing arrangement, cause the processing arrangement to perform a series of steps;
a network communication arrangement communicatively coupled to a mobile communication network, the network communication arrangement being removably configured within the device;
a right-hand side earpiece housing configured to be arranged relative to a right ear of a user, the right-hand side earpiece comprising:
a right-hand side outward surface;
a right-hand side inward surface;
a first driver configured to output acoustic signals;
a left-hand side earpiece housing configured to be arranged relative to a left ear of the user, the left-hand side earpiece comprising:
a left-hand side outward surface;
a left-hand side inward surface;
a second driver configured to output acoustic signals;
a first touchscreen display arranged on the right-hand side outward surface, the first touchscreen display being configured to display a dynamically updated first visual output and to receive a first tactile command from the user, wherein the first visual output is dynamically updated in response to the first tactile command; and
a second touchscreen display arranged on the left-hand side outward surface, the second touchscreen display being configured to display a dynamically updated second visual output and to receive a second tactile command from the user, wherein the second visual output is dynamically updated in response to the second tactile command.

2. The device of claim 1, wherein the first visual output and the second visual output are the same,
wherein the first visual output and the second visual output are dynamically updated simultaneously,
wherein the first visual output and the second visual output are dynamically updated in response to either the first tactile command or the second tactile command.

3. The device of claim 1, wherein the first visual output and the second visual output are different visual outputs,
wherein the first visual output and the second visually output are dynamically updated asynchronously,
wherein the first visual output is dynamically updated only in response to the first tactile command,
and wherein the second visual output is dynamically updated only in response to the second tactile command.

4. The device of claim 1, wherein the data storage arrangement is removable from the rest of the device.

5. The device of claim 1, wherein the data storage arrangement is configured to store audio files in the form of computer-readable data obtained from the mobile communication network via the network communication arrangement,
wherein the audio files are converted to the acoustic signals outputted to the user by the first driver and the second driver.

6. The device of claim 1, wherein the first tactile command and the second tactile command are performed simultaneously to produce a third tactile command.

7. The device of claim 6, wherein both the first visual output and the second visual output are dynamically updated in response to the third tactile command.

8. The device of claim 6, wherein only one of the first visual output or the second visual output is dynamically updated in response to the third tactile command.

9. The device of claim 1, wherein the first tactile command causes the first driver to produce a first auditory output, and wherein the second tactile command causes the second driver to produce a second auditory output.

10. The device of claim 6, wherein the first tactile command causes the first driver to produce a first auditory output,
wherein the second tactile command causes the second driver to produce a second auditory output,
and wherein the third tactile command causes the first driver and the second driver to produce a third auditory output.

11. The device of claim 6, wherein the first tactile command causes the first driver and the second driver to produce a first auditory output,
wherein the second tactile command causes the first driver and the second driver to produce a second auditory output,
and wherein the third tactile command causes the first driver and the second driver to produce a third auditory output.

12. The device of claim 1, further comprising a support member connecting the right-hand side earpiece housing and the left-hand side earpiece housing.

13. The device of claim 1, further comprising a rechargeable battery configured to supply electrical power to the first driver, the second driver, the first touchscreen display, the second touchscreen display, the processing arrangement, and the network communication arrangement.

14. The device of claim 1, further comprising an electric motor configured to produce vibrations in the right-hand side earpiece housing and the left-hand side earpiece housing.

15. The device of claim 14, wherein the processing arrangement causes the electric motor to produce the vibrations in a manner such that the vibrations start, stop, and increase in magnitude simultaneously with the acoustic signals outputted to the user by the first driver and the second driver.

16. The device of claim 14, wherein the electric motor is activated by at least one of the first tactile command or the second tactile command.

17. The device of claim 1, wherein the network communication arrangement comprises:
a SIM memory configured to store subscriber identity information, authentication data, and network access parameters;
a SIM processor coupled to the SIM memory and configured to execute instructions for performing authentication with the mobile communication network; and
a SIM contact interface configured to provide electrical communication between the SIM processor and the processing arrangement, wherein the SIM processor is further configured to transmit the subscriber identity information, authentication data, and network access parameters to the processing arrangement in response to a request signal received through the SIM contact interface.

18. The device of claim 17, wherein the transmission of subscriber identity information, authentication data, and network access parameters from the SIM processor to the processing arrangement is controlled by one of the first tactile command or the second tactile command.

19. A system comprising:
a mobile communication network;
a central database communicatively coupled to the mobile communication network, the central database comprising a central database memory;
a device comprising:
a processing arrangement;
a data storage arrangement comprising a non-transitory computer-readable medium containing instructions that, when executed by the processing arrangement, cause the processing arrangement to perform a series of steps;
a network communication arrangement communicatively coupled to a mobile communication network, the network communication arrangement being removably configured within the device;
a right-hand side earpiece housing configured to be arranged relative to a right ear of a user, the right-hand side earpiece comprising:
a right-hand side outward surface;
a right-hand side inward surface;
a first driver configured to output acoustic signals;
a left-hand side earpiece housing configured to be arranged relative to a left ear of the user, the left-hand side earpiece comprising:
a left-hand side outward surface;
a left-hand side inward surface;
a second driver configured to output acoustic signals;
a first touchscreen display arranged on the right-hand side outward surface, the first touchscreen display being configured to display a dynamically updated first visual output and to receive a first tactile command from the user, wherein the first visual output is dynamically updated in response to the first tactile command;
a second touchscreen display arranged on the left-hand side outward surface, the second touchscreen display being configured to display a dynamically updated second visual output and to receive a second tactile command from the user, wherein the second visual output is dynamically updated in response to the second tactile command; and
audio files in the form of computer-readable data stored in the central database memory, the audio files being configured to be transmitted from the central database memory to the data storage arrangement of the device via the mobile communication network upon receipt of at least one of the first tactile command or the second tactile command,
wherein the audio files are converted to the acoustic signals outputted to the user by the first driver and the second driver.

20. The system of claim 19, wherein the network communication arrangement comprises:
a SIM memory configured to store subscriber identity information, authentication data, and network access parameters;
a SIM processor coupled to the SIM memory and configured to execute instructions for performing authentication with the mobile communication network; and
a SIM contact interface configured to provide electrical communication between the SIM processor and the processing arrangement, wherein the SIM processor is further configured to transmit the subscriber identity information, authentication data, and network access parameters to the processing arrangement in response to a request signal received through the SIM contact interface.
